(19) United States
(12) Patent Application Publication
(10) Pub. No.: US 2026/0338908 A1
(43) Pub. Date: Oct. 29, 2026

(54) METHOD AND DEVICE TO IMPROVE REPEATED DETERMINATION OF A DISTANCE OR ORIENTATION USING RADIO SIGNALS

(71) Applicant: Lambda:4 Entwicklungen GmbH, Hamburg (DE)

(72) Inventor: Rönne REIMANN, Hamburg (DE)

(73) Assignee: Lambda:4 Entwicklungen GmbH, Hamburg (DE)

(21) Appl. No.: 19/653,245

(22) Filed: Apr. 21, 2026

(30) Foreign Application Priority Data
Apr. 23, 2025 (DE) 102025115624.7
Aug. 12, 2025 (EP) 25195466.5
Oct. 2, 2025 (EP) 25206530.5

(51) Int. Cl. G01S 5/02

(52) U.S. Cl. CPC G01S 5/021

(57) ABSTRACT

A method and corresponding device to improve repeated determination of a distance or orientation using radio signals. Devices often have differing hardware or differing control systems for this hardware. The method optimizes repeated determination of the objects, in particular in the case that they have differing hardware. The method includes storing the detected properties of the objects and referring to them for subsequent determinations. When doing so, properties of one single object or a sub-set of the totality of the objects or a group, in particular pair, of objects, can be stored and used later. In addition to this, the security of authorizations carried out via a radio link should be optionally improved, which is also possible using the stored properties. In addition to this, to further enhance security, storage can be made dependent on whether specific security characteristics or other requirements have been met.

### TECHNICAL FIELD

The invention relates to a method and corresponding device to improve repeated determination of a distance and/or orientation using radio signals.

### BACKGROUND ART

In many cases, the distance and/or angle, in particular the relative orientation, between specific objects, in particular a pair of objects, is determined repeatedly. In addition, in the case of a group of objects, this procedure is often carried out repeatedly between variable subsets, in particular pairs, of objects in the group.

When doing so, devices often have differing hardware or differing control systems for this hardware, which allow for different, or no, optimization of the determination. On the one hand, it is disadvantageous to always assume the worst-case scenario; on the other the assumption of the best case results in problems when the existing situation is actually worse. Furthermore, determination of appropriate possible optimizations or of the actual scenario are complex, in particular resulting in time and energy losses.

### SUMMARY OF THE INVENTION

The task of this invention is to optimize repeated determination, in particular in case the objects have differing hardware (in particular of such a nature that different optimizations between different pairs are possible). Optimizations in this regard could, for example, refer to speed, energy or also security features.

Hardware differences may, for example, arise due to the use of different chip sets, in particular Bluetooth chip sets; different filters; different amplifiers; or also different control systems for the hardware. Even objects created using hardware of the same model/designation/type may, however, demonstrate such differences, for example due to manufacturing fluctuations.

Roughly outlined, the task is solved by storing the detected characteristics of the objects and referring to them for subsequent determinations. When doing so, characteristics of one single object or a sub-set of the entirety of the objects or a group, in particular pair, of objects, can be stored and used later. In addition to this, as the security of authorizations carried out via a radio link should be optionally improved, which is also possible using the stored characteristics. In addition to this, to further enhance security, storage can be made dependent on whether specific security characteristics or other requirements have been met.

The task is solved by a method for repeated determination of the distance and/or an angle and/or orientation (hereinafter also referred to merely as “determination”) between at least two objects on the basis of measured values of radio signals between at least the two objects,
whereby it is determined whether at least one predetermined characteristic of at least the first object is known from the previous determinations between the two objects and the determination, in particular the readout, is carried out pairwise regarding two objects, a first and a second of the at least two objects, at least with regard to the first of the two objects, in particular of both objects, and
the determination is carried out dependent on the result of the determination, whether at least one predetermined characteristic of at least the first object is known,
whereby the predetermined characteristic is at least one of the following:
   Degree of deviation between PBR (phase based ranging) and TBR (signal (round) trip time based ranging),
   Problematic frequency/frequencies,
   Phase predictability when the frequency is changed,
   Constancy of the phase and/or amplitude between re-transmissions, in particular sub-events,
   Degree of the transmission direction asymmetry,
   Non-linearity of the phase when the frequency is changed, in particular a degree of the non-linearity
and whereby
in case the degree of deviation between PBR and TBR is known, an, in particular frequency-dependent, correction of the deviation between PBR and TBR measurement is carried out and/or
in case at least one problematic frequency is known, the measured values on the at least one problematic frequency are given a lower weighting or not taken into account for the determination and/or
in case the phase predictability when the frequency is changed is known, no 180° phase ambiguity decision is carried out and/or, on at least one frequency, one or two one-way channel measurements is/are used instead of a signal round trip or two-way measurement, i.e. in particular, measurement based on each outward and return radio signal, in particular on the same frequency, is/are used for determination, and/or the number of frequencies and/or antenna paths on which measurements for determination are used is reduced, and/or
in case the constancy of the phase and/or amplitude is known and between the repeating of measurements on the frequencies repeated for determination at the beginning of a repeat, in addition to the measurements on the frequencies to be repeated, in particular the immediate prior radio signal and/or radio signal which are repeated are used, or a selection decision between the measurements on the frequencies to be repeated and measurements on the repeated frequencies is made, and/or wherein the constancy of the phase and/or amplitude is known, no correction value is determined for the phase and/or amplitude between the repeats and/or
in case the degree of transmission direction asymmetry is known, the measured values are corrected to reduce the transmission direction asymmetry in the measured values and/or
in case the non-linearity of the phase when the frequency is changed is known, the range of the frequency range used for determination is adjusted, in particular is reduced in case there is high non-linearity, and/or, in particular in case a degree is known, the measured values are corrected.

When doing so, it is fundamentally sufficient for improvement if one of the predetermined characteristics is used, i.e. in particular for determination, storage and reading out, and this determined predetermined characteristic is used for determination. Depending on the scenario, every sub-combination of these predetermined characteristics increases the improvement vis-à-vis the use of only one predetermined characteristic. Depending on the scenario, increasing the number of predetermined characteristics used further increases the improvement. Preferred embodiment described regarding multiple predetermined characteristic are preferred as well with embodiments using only one predetermined characteristic.

The degree of deviation between PBR and TBR can include an, in particular, at least frequency-dependent correction, e.g. offset value and/or factor.

The problematic frequency/frequencies can, in particular, include and/or be a list of the problematic frequencies for determination measurements.

The problematic frequency(ies) are, in particular, those at which interference in transmission and/or measurements is to be expected and/or has been repeatedly observed, especially in case these interferences exceed a predetermined limit or a limit determined through measurements. These could be, for example, the frequencies of the harmonics of a quartz crystal in the object.

Such problematic frequencies can be identified, for example, as follows: For multiple radio transmissions on different frequencies, the trend of an I/Q value, an I and/or a Q value, an amplitude and/or phase value, and especially the trend of changes to the values caused by the transmission, is smoothed across the frequency span. For each transmission, the deviation from the smoothed trend is then determined. From this, preferably disregarding any outliers, an average deviation can be calculated. If a deviation exceeding the mean deviation by more than a predetermined factor, for example 2 or 3, is repeatedly observed at a given frequency or with a relative frequency of exceeding higher than a predetermined relative frequency of exceeding, e.g. 10%, this given frequency may be classified as a problematic frequency.

The characteristic phase predictability when the frequency is changed may e.g. be a binary parameter and/or specify what calculation is required for prediction.

The “constancy of the phase and/or amplitude between re-transmissions, in particular sub-events” characteristic can be a binary parameter, in particular for the phase and for the amplitude, each.

The “degree of the transmission direction asymmetry” characteristic can, in particular, specify whether a correction is possible and appropriate; a correction is not possible; and/or whether a correction is not required. Alternatively and/or additionally, it can include information that must be used for correction. In the case of this characteristic in particular, it may be appropriate not to store and read it out for a single object, but instead for a pair of objects. It is, however, also possible to store this characteristic on a single object. The latter is a particular option if this characteristic has already been determined for an object, for example by means of (more extensive) measurement.

The “non-linearity of the phase when the frequency is changed, in particular a degree of the non-linearity” may, for example, be a binary parameter and/or include correction information for correction of the linearity deviation.

It has proven to be particularly advantageous if the “phase predictability when the frequency is changed” characteristic is used, the “degree of the transmission direction asymmetry” characteristic is used as well, because this enables the use of particularly reliable and energy-saving one-way channel response for determination.

Use of the stored predetermined characteristics not only enables more efficient determination, but also allows the parameters for security checks to be defined more narrow because the stored predetermined characteristics can be used to level out the differences between various objects. This reduces variation and thus allows limits for verification to be defined more narrower, enhancing security further.

Insofar as, when carrying out a determination, there are still insufficient stored predetermined characteristics to tighten security verifications, it can be advantageous to work with additional security requirements (e.g. passwords, certificates, wider bandwidth, more radio signals), which may, at least in part, be dispensed with when at least one or sufficient stored determined predetermined characteristics are present to tighten security verifications.

The method is thus in particular carried out in such a way that further security verifications like password requirement are lowered when a predetermined quantity of stored predetermined eristics and/or predetermined accuracy is given and/or a predetermined maximum age of stored predetermined eristics for a determination in particular between two objects and/or for the granting or denial of access and/or clearance at least, among other things, on the basis of the determination, in particular in comparison to afirst determination between the two objects and/or for the storage of predetermined characteristics and/or when such is not is given.

In particular in the case of an access/clearance system that includes one of the two objects, in particular, the second, such as a car, the predetermined quantity/accuracy/ maximum age can also refer solely to the other, in particular the first, object, especially stored predetermined characteristics regarding such.

In the case of the predetermined characteristics for an access/clearance system that includes one of the two objects, in particular the second, it is also advantageous to store the predetermined characteristics in the access/clearance system and/or make them (only) accessible to the access/clearance system and/or not accessible to the first object.

The exchange of radio signals between two objects is, in particular, understood as the transmission of at least one radio signal in one direction between the two objects and, in particular as a reaction to this, the transmission of at least one radio signal in the reverse direction between the two objects directly or later. When doing so, in particular, the same frequency/frequencies is/are used for the forward and return paths. This is, in particular, repeated multiple times.

The measurements can be, for example, propagation time measurements (in particular TBR); phase measurements (in particular PBR) and/or amplitude measurements, in particular propagation time measurements (in particular TBR) and amplitude measurements and/or phase measurements (in particular PBR) as well as amplitude measurements. In this context, values are measured on the radio signals, at least for each object that receives the other object's radio signals. In addition to this, measurements on the own signals emitted or on signals used to form the radio signal for transmission may be taken.

Transmission of the radio signals may preferably be carried out via a number of different antenna paths, in particular for each direction (forward/return).

The predetermined characteristics can relate to one object or to a plurality of objects, in particular a pair of objects. Correspondingly, the check whether predetermined characteristics are known may, for example, be carried out for one of the objects, both of the objects and/or for the pair.

Advantageously, in particular dependent on determined channel quality and/or predetermined security features, e.g. of the received signal(s), at least one of the predetermined characteristics of at least one of the two objects, in particular one or at least in each case at least one predetermined characteristic of both objects and/or one predetermined characteristic of the pair of two objects, is stored for a subsequent readout, in particular insofar as and/or only insofar as successful authorization has taken place and/or in case at least one of the following has been determined: a link quality that meets a predetermined minimum link quality; a distance (in particular between the two objects) that does not exceed a predetermined maximum distance; a signal strength of received radio signals between the two objects that reaches a predetermined minimum signal strength; a measurement value consistency that reaches a predetermined minimum consistency and/or of a distance, in particular a relative position, of at least one of the two objects, in particular to the other object, that meets a predetermined distance requirement and/or predetermined relative position requirement, for example directly in front of an access restriction device, such as a door or barrier, and/or a predetermined (relatively defined) volume, such as inside a car.

The consistency of the measured values may, for example, be determined by whether the shortest measured distance also demonstrates the strongest signal components and/or whether the distance spectrum for the signals is sufficiently narrow, in particular does not exceed a predetermined maximum width.

Security features can be obtained from measurements on the radio signals; they may, however, in addition or alternatively also include authorizations, for example via certificates or encryption procedures, and thus also be the result of corresponding checks.

Storage may, preferably in addition and/or first, be carried out independently of, in particular before, the determination, thus for example during manufacturing, delivery and/or commissioning.

Storage may, for example, be located in one of the objects, in particular in the respective other object and/or in both objects. Remote storage is, however, also alternatively and/or additionally possible. In particular, other objects can thus also be granted access to stored predetermined characteristics, independent of the object whose determined and stored predetermined characteristics are read out. This enables the use of additional security mechanisms independent of the respective object that is concerned. The object whose predetermined characteristics are stored may, however, also store these predetermined characteristics and make them available to other objects, in particular during or before determination, in particular via a radio link.

Advantageously, stored predetermined characteristics are adjusted after use for a determination, whereby in particular maximum changes and/or deviations are predetermined for this purpose and/or whereby the adjustment is only carried out in case the determination is successful and/or predetermined security characteristics are met and/or dependent on the determination; channel quality and/or predetermined security characteristics, in particular insofar as successful authorization has taken place and/or at least one of the following has been determined: a link quality that meets a predetermined minimum link quality; a distance, in particular between the two objects, that reaches a predetermined maximum distance; a signal strength of received radio signals between the two objects that meets a predetermined minimum signal strength; a measurement value consistency that reaches a predetermined minimum consistency; and/or a distance, in particular a relative position, of at least one of the two objects, in particular to other, that meets a predetermined requirement for the distance and/or relative position.

This, for example, makes it possible to compensate for creeping changes in the hardware.

Advantageously, in particular all, stored determined predetermined characteristics are deleted and/or not used insofar as a predetermined time has elapsed and/or at least one relevant predetermined change that is relevant for at least one of the two objects has occurred to at least one of the objects since the last determination, in particular a software update since their last, in particular successful, use for determination and/or successful authorization between the two objects and/or storage.

The adjustment of a stored and/or used determined predetermined characteristic after a new determination of the predetermined characteristic can be carried out, for example, by replacing the stored and/or used predetermined characteristic with the newly determined predetermined characteristic, or by calculating a (weighted) average between the old and new value of the predetermined characteristic and storing and/or subsequently using this average as determined and/or to-be-stored predetermined characteristic. Predetermined limits on the change of the stored predetermined characteristic may then be imposed, limiting the extent of the change, for example, with each individual change and/or depending on the elapsed time and/or a measure of previously made changes.

This makes it possible to absorb abrupt changes such as software changes and thus how hardware is controlled and thus to increase the method's robustness, avoiding random influences to have too great an impact on the stored predetermined characteristics.

Advantageously, the determination between the two objects is carried out repeatedly, in particular using an intermittent radio connection by at least one of the two objects to another object via the same radio interface, which is used to transmit the radio signals for determination.

Repeated determination makes it possible to make particularly good use of the method's advantages; equally, it demonstrates its particular strength when the determination is carried out between different pairs, for example in random order. This is, for example, the case when using multiple “keys” (key fobs, cell phones, smart watches, . . . ) for one access, for example to a car.

Preferably, the radio signals are exchanged via Bluetooth, in particular if they are channel-sounding signals and/or demonstrate a corresponding and/or pairwise constant frequency and/or are not modulated radio signals. This type of signal has proven to be particularly suitable for carrying out the method. In addition to this, many devices are capable of emitting and measuring such signals.

Advantageously, each object has a unique ID that is used to detect the objects and/or to assign the stored predetermined characteristics to an object. Such an ID can, for example, be defined by the radio interface that is used or also via software used to carry out the method and assigned to each object that participates in the method. It can, for example, be used to query, identify and/or assign stored predetermined characteristics.

In a decentralized configuration of the method, the predetermined characteristics of the first object that should be stored can also be stored so that they are accessible at least or only on the second object and/or the stored predetermined characteristics are transferred between the objects prior to the determination. This also applies in particular in reverse (with regard to the first/second object).

The objects can centrally store and query the determined predetermined characteristics in a central system, in particular a server architecture and/or anchor node, in particular one or more connected servers.

It can also be advantageous for storage and/or transfer of the determined predetermined characteristics to be carried out, in particular asymmetrically, encrypted.

The determined predetermined characteristics of the first object that should be stored can be stored in a central system that can be accessed by the second object independently of the first object. Embodiments that involve the first device are, however, also conceivable, for example for authentication and/or decryption, in order to access centrally stored determined predetermined characteristics of the first device. This also applies in particular in reverse (with regard to the first/second object).

Advantageously, a (further) radio interface can be used to transmit the determined and/or stored predetermined characteristics for storage and/or for querying, in particular via the Internet, and/or via an, in particular mobile, data connection.

It is particularly preferred if at least one of the two objects, in particularly both, uses a plurality of transmitting and/or receiving devices to transmit respectively receive the radio signals used for determination. This makes it possible to increase accuracy and robustness. Generally, two transmitting and/or receiving devices per object are sufficient for this. In this case, at least one, in particular all, device(s) per object is/are preferably used as transmitting and receiving device(s), so that, preferably in the first and/or second object, two devices, in particular antennas, are used to transmit and receive the radio signals used for determination.

Advantageously, the method includes granting of access and/or clearance; carrying out of a requested action or operation and/or the omission of an alarm or blocking, insofar as at least (there may be further preconditions, such as successful authentication) the result of the determination meets at least one predetermined requirement.

Advantageously, the method includes denial of access and/or clearance; omission of a requested action or operation and/or activation of an alarm or blocking, insofar as at least the result of the determination does not meet one predetermined requirement and/or the predetermined characteristic of the first object that is identified via the radio signals, in particular emitted by the first object, demonstrates a predetermined deviation of at least one stored predetermined characteristic of the first object.

The predetermined requirement may, for example, be establishing a link quality that meets a predetermined minimum link quality; a distance (in particular between the two objects) that does not exceed a predetermined maximum distance; a signal strength of received radio signals between the two objects that reaches a predetermined minimum signal strength; a measurement value consistency that reaches a predetermined minimum consistency; and/or a distance, in particular a relative position of at least one of the two objects, that meets a predetermined distance requirement and/or predetermined relative position requirement, for example directly in front of an access restriction device, such as a door or barrier, and/or a predetermined (relatively defined) volume, such as inside a car.

The method is particularly good for efficient protection, for example of access/clearance, because it makes it possible to place particularly high requirements on the radio signals if stored predetermined characteristics are used for determination.

Advantageously, if the determination between the objects fails and exceeds a predetermined number of attempts, the stored predetermined characteristics of the first and/or second object, are, at least partially, ignored and/or deleted during determination, in particular until after the next successful determination between the objects.

This makes it possible to increase the method's robustness, for example as regards abrupt changes.

Advantageously, the stored predetermined characteristics are used to increase requirements regarding the radio signals. In this regard, requirements are, in particular, the ones listed above as examples and/or the ones used to make a decision regarding an authentication, an access or a clearance.

Advantageously, stored predetermined characteristics are used to accelerate the determination and/or the measurements on which determination is based using radio signals and/or to make the process more energy efficient and robust vis-à-vis environmental influences, in particular insofar as one of the objects has more precise hardware than should be assumed in the worst case, in particular by omitting frequencies, antenna paths and/or calculations.

Preferably, the method is carried out using one, or a plurality, of the devices described below and/or the devices described below are configured to carry out one of the methods described above. To do this, the device has, in particular, at least one control unit that is configured to control carrying out of the method.

Advantageously, the method is carried out using at least one listening, in particular passive, third object that receives the radio signals between the first and the second object and carries out measurements on the received radio signals, whereby the measurements are taken into account for the determination and take into account at least one stored predetermined characteristic of the first, second and/or third object.

In principle, it is widely known to use a listening object. This may, for example—in particular with the first or second object—be part of an anchor network and/or an access restriction system. The listening object may also, for example, transmit signals to determine predetermined characteristics, which is preferred. It is, in particular, however, characterized by the fact that it does not transmit sufficient radio signals to determine the distance and/or an angle and/or not to transmit during measurements for determination. When doing so, the measured values of the third object may, for example, be used for improvement, in particular with regard to precision, reliability or speed, and/or for (additional) protection against attacks, such as relay or early-detect-late-commit attacks, in particular if the third object is at a fixed and/or known spatial placement to the first or second object, which is preferred.

It is of particular importance that the listening object advantageously determines the degree of transmission direction asymmetry to at least one of the two (first and second) objects via its own transmission. This significantly increases the method's robustness in contrast to a purely passive third object.

As regards the measurements of the third object, in particular
in case the degree of deviation between PBR and TBR is known, an, in particular frequency-dependent, correction of the deviation between PBR and TBR measurement is carried out and/or
in case at least one problematic frequency is known, the measured values on the at least one problematic frequency are given a lower weighting or not taken into account for the determination and/or
in case the phase predictability when the frequency is changed is known, no 180° phase ambiguity decision is carried out and/or
in case the constancy of the phase and/or amplitude is known between repeatings of measurements, measurements on frequencies repeated at the beginning of a repeat, in addition to the measurements on the frequencies to be repeated in particular the immediate prior radio signal and/or radio signal which are repeated are used for determination, or a selection decision between the measurements on the frequencies to be repeated and measurements on the repeated frequencies is made, and/or
in case the degree of transmission direction asymmetry is known, the measured values are corrected to reduce the transmission direction asymmetry in the measured values and/or
in case the non-linearity of the phase when the frequency is changed is known, the range of the frequency range used for determination is adjusted, in particular is reduced in case there is high non-linearity, and/or, in particular in case a degree of non-linearity of the phase when the frequency is changed is known, the measured values are corrected.

In principle, it is particularly preferred to adopt, in particular, optimize, for example as regards energy, the emission of the radio signals by using at least one stored predetermined characteristic. This can be caried out for at least one known problematic frequency, for example by not transmitting any radio signal for determination on the at least one problematic frequency or by not only reducing the frequency range of the radio signals used for determination, but also already reducing the range of radio signals transmitted for determination, generally, for example, by reducing the quantity of radio signals.

The task is also solved by a transceiver, in particular a first or second object, in particular a key fob, cell phone and/or component of an access restriction system, in particular of a vehicle, demonstrating a radio interface and a computing unit as well as a storage unit and, in particular, a communications interface, in particular demonstrating a further radio interface, configured to carry out the method, in particular with a transceiver as per the invention in particular as a first object.

The task is also solved by a system, in particular an access restriction system, in particular as a second object, in particular of a vehicle, featuring at least one transceiver and/or a plurality of transmitting and/or receiving devices configured to carry out the method, in particular with an identical transceiver, in particular as another, in particular as a second or first, object.

The task is also solved by a group of at least a total of three, in particular at least four, transceiver(s) and/or system(s) configured to carry out the method pairwise, in particular as a first and a second object.

Preferably, if not specified to the contrary determination refers to the determination of distance and/or angle.

### BRIEF DESCRIPTION OF THE DRAWINGS

The following, purely illustrative, description of the purely illustrative, schematic figures contributes to a better understanding of the invention. In this regard the following figures show:

FIG. 1 A depiction of the invention within the scope of a car locking system and

FIG. 2 A depiction of a possible method sequence and

FIG. 3 A depiction of the reliability advantages based on a possible sequence of the method and

FIG. 4 A depiction of the security advantages based on a possible sequence of the method and

FIG. 5 A depiction of the speed advantages based on a possible sequence of the method and

FIG. 6 A comparison of the unlocking speed of a car using a method as per the invention (AQUAA) and a conventional method (no AQUAA) and

FIG. 7 A comparison of the reliability when unlocking a car using a method as per the invention (AQUAA) and a conventional method (no AQUAA) and

FIG. 8 A comparison during an attack to unlock a car using a method as per the invention (AQUAA) and a conventional method (no AQUAA).

### DETAILED DESCRIPTION

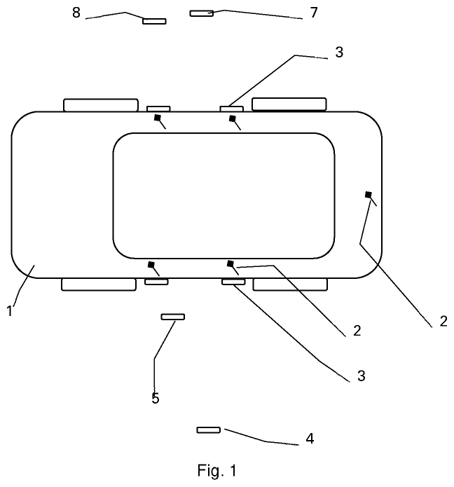

FIG. 1 shows a view of a car (1) from above; second objects (2) are placed next to the door and trunk handles (3). In addition to this, fobs, smart phones and similar (transponder/transceiver) that are authorized to unlock the car are depicted (4, 5, 7, 8).

In each case, the fobs, smart phones and similar (transponder/transceiver) (4, 5, 7, 8) are the first object. The first and second objects form a group of objects. The second objects form an anchor network and are part of a car access and clearance system. They are connected to each other using data technology and communicate with a central server in the car that stores predetermined characteristics of first objects and makes queries to these characteristics.

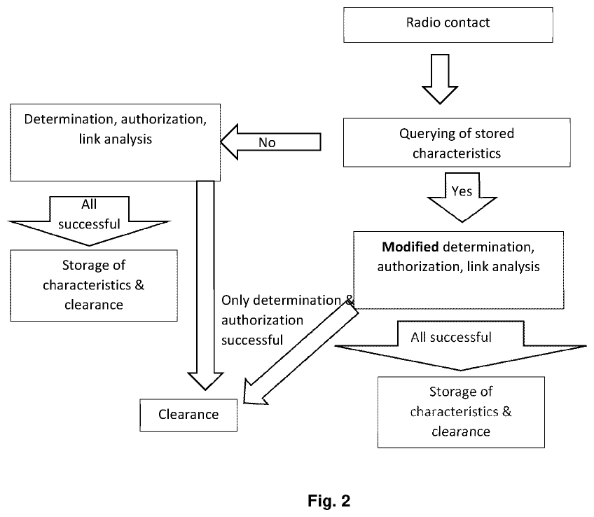

FIG. 2 shows a possible sequence method of the method. After establishing radio contact between a first and a second object and exchanging IDs, the stored characteristics of the two objects are queried. If such characteristics are available and valid, the determination is correspondingly modified (more robust, more precise, energy-saving and/or additionally secured by more narrow limits) in addition to an authorization, for example via certificates, and an analysis of the quality of the radio link (link analysis), for example based on radio signals transmitted within the scope of determination or on measurements of predetermined characteristics during determination. If everything meets corresponding predetermined requirements, a clearance, for example ignition of a car, and storage of (newly) determined characteristics, which were determined during the determination, is carried out.

If no valid, stored predetermined characteristics are available, an unmodified determination, authorization and link analysis are carried out. If everything meets corresponding predetermined requirements, a clearance, for example ignition of a car, and storage of (newly) determined characteristics, which were determined during the determination, is carried out.

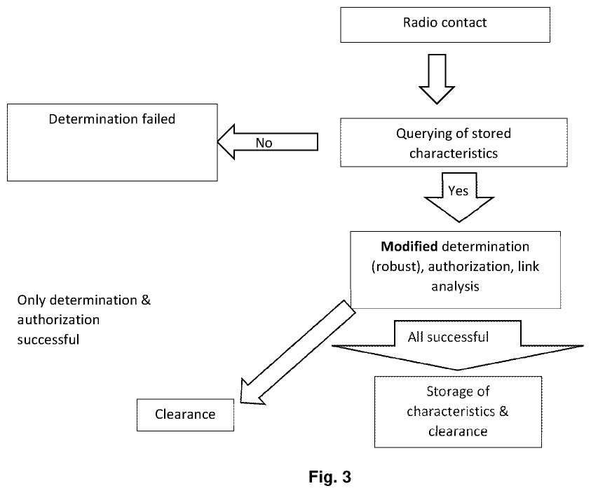

FIG. 3 shows various scenarios for the same radio signals. After establishing radio contact between a first and a second object and exchanging IDs, the stored characteristics of the two objects are queried. If such characteristics are available, the determination is correspondingly modified (more robust by excluding problematic frequencies and more precise by adjusting measurements based on stored characteristics, . . . ) and an authorization, for example via certificates, and an analysis of the quality of the radio link (link analysis) are carried out (right branch in the illustration). Use of stored characteristics enables a determination to be carried out successfully even if the link quality is poor (for example due to interference), depending on the severity of the interference, with sufficient link quality for updated storage of predetermined characteristics or only sufficient for clearance.

In case radio signals and the environment remain unchanged, i.e. same link quality, it may not be possible to carry out the determination successfully without stored predetermines characteristics (left branch in the illustration).

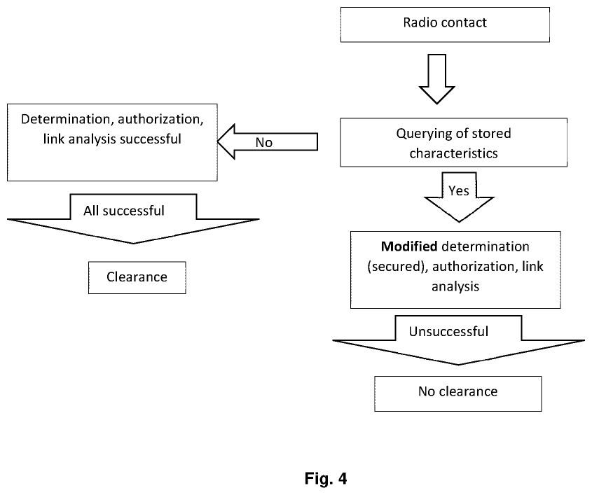

FIG. 4 shows various scenarios for the same radio signals. After establishing radio contact between a first and a second object and exchanging IDs, the stored characteristics of the two objects are queried. If such characteristics are available, the determination is correspondingly modified (more secure thanks to more narrow limits) and an authorization, for example via certificates, and an analysis of the quality of the radio link (link analysis) are carried out (right branch in the illustration). In the case of an attack, for example early-detect-late-commit, use of stored characteristics enables a third object to determine more securely/better that unauthorized intervention has taken place and to refuse clearance.

In case radio signals and the environment remain unchanged, i.e. same attack, clearance would have been granted if more narrow had not been set using the stored predetermined characteristics (left branch in the illustration).

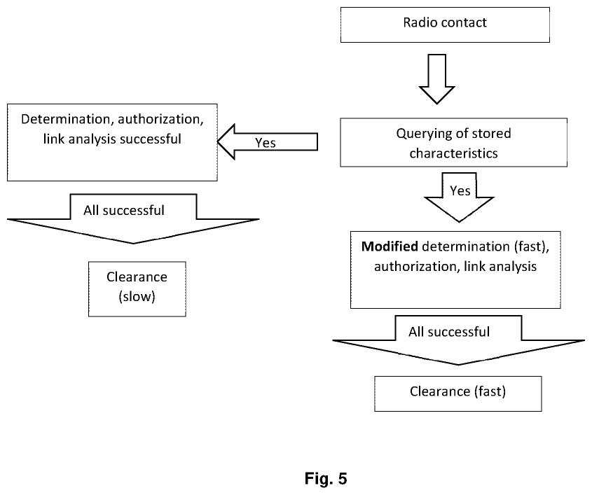

FIG. 5 shows various scenarios for the same radio signals. After establishing radio contact between a first and a second object and exchanging IDs, the stored characteristics of the two objects are queried. If such characteristics are available, the determination is correspondingly modified (use of fewer frequencies) and an authorization, for example via certificates, and an analysis of the quality of the radio link (link analysis) are carried out (right branch in the illustration). Using the stored characteristics allows a clearance to be carried out faster and more energy efficiently.

If stored predetermined characteristics (left branch of the illustration) are not used, clearance is also granted, however it is granted later and consumes more energy.

The examples in FIG. 3 through 5 show aspects in a largely isolated manner. They can, however, all be used together.

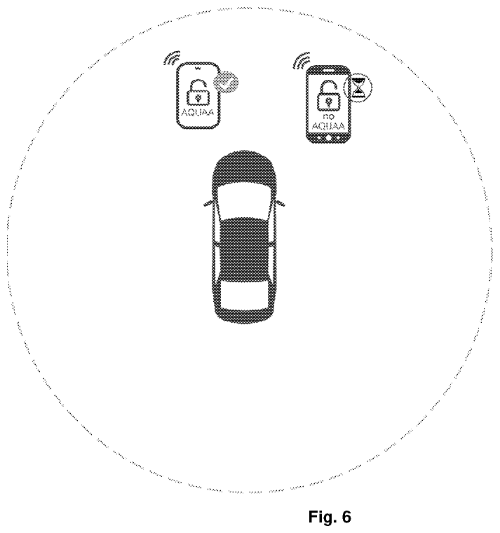

FIG. 6 shows a car being unlocked using a cell phone. The circle identified by the dashed line represents an area within which it should be possible to unlock the car. The cell phone (left, AQUAA) that can perform the inventive method as per the invention—and regarding which the vehicle has already store corresponding predetermined characteristics—can unlock the vehicle very quickly, while conventional methods (no AQUAA) require significantly longer. In this scenario, both unlock the car correctly.

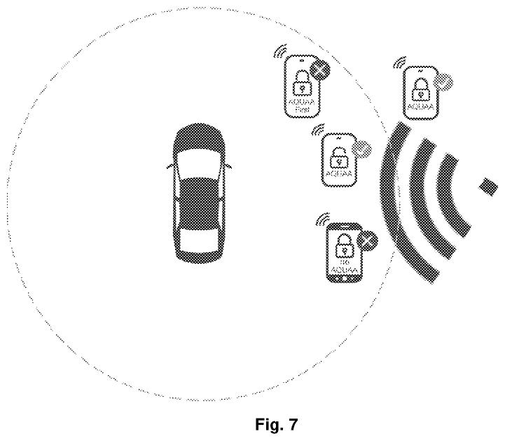

FIG. 7 shows the car and the unlocking radius as in FIG. 6. There is, however, an external interfering radio signal, meaning that radio communications are interfered with.

Cell phones without previously stored predetermined characteristics fail, while cell phones as per the invention are able to unlock the car within the unlocking radius (symbolized by the open circle). The correct operation is identified by a circle with a check mark, in contrast to a circle with an X mark.

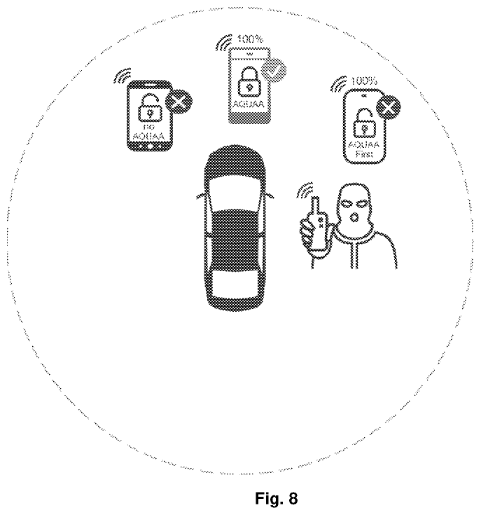

FIG. 8 shows a scenario with an attack on radio communications. Stored predetermined characteristics of the middle cell phone that are stored in the vehicle enable the attack to be determined and unlocking to be denied, thus achieving the desired behavior. In regard to devices not as per the invention or regarding such regarding which no predetermined characteristics have yet been stored cause the check to fail to the extent that the attacker is able to unlock the vehicle. While such an event can generally still be prevented by stricter checks and sufficient hardware, this negatively impacts the time and energy that is required. This can be tolerated the first time that a cell phone working as per the invention establishes communications with the car, however, cannot generally be permanently tolerated.

### LIST OF REFERENCE MARKINGS

1 Car
2 Second Object
3 Door Handle
4 First Fob
5 Second Fob
6 Third Fob
7 Fourth Fob

What is claimed is:

1. A method for repeated determination of a distance or an angle between at least two objects on the basis of measured values on radio signals between the at least two objects, the method comprising:
determining if at least one predetermined characteristic of at least the first object is known from previous determinations between the two objects;
carrying out the determination pairwise regarding two objects, a first and a second of the at least two objects, at least with regard to the first of the two objects;
carrying out the determination of the distance or an angle dependent on the result of the determination whether at least one predetermined characteristic of at least the first object is known;
wherein the predetermined characteristic is at least one of the following: a degree of deviation between PBR and TBR, at least one problematic frequency, a phase predictability when the frequency is changed, a constancy of a phase or an amplitude between re-transmissions, a degree of a transmission direction asymmetry, a non-linearity of the phase when the frequency is changed;
wherein if the degree of deviation between PBR and TBR is known, the method further comprises:
carrying out a correction of the deviation between PBR and TBR measurement;
wherein if the at least one problematic frequency is known, the method further comprises:
giving the measured values on the at least one problematic frequency a lower weighting or not taking the measured values on the at least one problematic frequency into account;
wherein if the phase predictability when the frequency is changed is known, the method further comprises:
not carrying out 180° phase ambiguity decision, or
using one or two one-way channel measurements on at least one frequency instead of a signal round trip measurement for determination, or
reducing the number of frequencies or antenna paths on which measurements for determination used is reduced;
wherein if the constancy of the phase or amplitude is known between repeatings of measurements, the method further comprises:
using measurements on frequencies repeated at the beginning of a repeat, in addition to the measurements on the frequencies to be repeated or radio signal which are repeated for determination, or
making a selection decision between the measurements on the frequencies to be repeated and measurements on the repeated frequencies;
wherein if the degree of transmission direction asymmetry is known, the method further comprises:
correcting the measured values to reduce the transmission direction asymmetry in the measured values;
wherein if the non-linearity of the phase when the frequency is changed is known, the method further comprises:
adjusting the range of the frequency range used for determination is adjusted, or
correcting the measured values.

2. The method according to claim 1, further comprising:
storing, dependent on the determination of channel quality or predetermined security characteristics, at least one of the predetermined characteristics of at least one of the two objects for subsequent reading out,
determining if at least one of the following has occurred:
a link quality that meets a predetermined minimum link quality;
a distance that does not exceed a predetermined maximum distance;
a signal strength of received radio signals between the two objects that reaches a predetermined minimum signal strength;
a measured value consistency that reaches a predetermined minimum consistency or of a distance of at least one of the two objects that meets a predetermined distance requirement or predetermined relative position requirement.

3. The method according to claim 2, further comprising:
adjusting at least one stored predetermined characteristic after use for a determination, wherein at least one maximum changes or deviations are predetermined for this purpose
determining if at least one of the following has been occurred:
a link quality that meets a predetermined minimum link quality;
a distance that does not exceed a predetermined maximum distance;
a signal strength of received radio signals between the two objects that meets a predetermined minimum signal strength;
a consistency of measured values that reaches a predetermined minimum consistency; or
a distance that meets a predetermined requirement for the distance or relative position.

4. The method according to claim 2, wherein the at least one stored predetermined characteristic is deleted or not used insofar as a predetermined time has elapsed or at least one relevant predetermined change that is relevant for at least one of the two objects has occurred to at least one of the objects since the last determination.

5. The method according to claim 1, wherein the determination between the two objects is carried out repeatedly which is used to transmit the radio signals for determination.

6. The method according to claim 1, wherein the radio signals are exchanged via Bluetooth, and each object has a unique ID that is used to detect the objects or to assign the stored predetermined characteristics to an object.

7. The method according to claim 1,
storing the at least one predetermined characteristic of the first object on the second object or in way that they are also accessible at least or only by the second object independent of the first object or
transferring the stored predetermined characteristics between the objects by radio signals prior to the determination or
transmitting the predetermined characteristics for storage or for querying via a further communications interface or
wherein the objects store and query the determined predetermined characteristics centrally.

8. The method according to claim 1, wherein at least one of the two objects features a plurality of transmitting or receiving devices to transmit respectively receive the radio signals and uses them for transmission respectively reception for the purpose of determination.

9. The method according to claim 1, wherein the method further comprises:
granting of access or clearance or carrying out of a requested action or operation or the omission of an alarm or blocking, insofar as at least the result of the determination meets at least one predetermined requirement or
denying access or clearance if at least one predetermined characteristic of the first object that is identified sowing in the radio signals demonstrates a predetermined deviation of at least one stored predetermined characteristic of the first object.

10. The method according to claim 3, wherein stored predetermined characteristics of the first or second object are, at least partially, ignored or deleted if the determination between the objects continuously fails, exceeding a predetermined number of attempts.

11. The method according to claim 3, wherein stored predetermined characteristics are used to accelerate the determination or the measurements on which determination is based using radio signals or to make the process more energy efficient or robust vis-à-vis environmental influences.

12. The method according to claim 1, further comprising:
using at least one listening third object that receives the radio signals between the first and the second object and carries out measurements on the received radio signals for determination;
taking into account the measurements for the determination and take into account at least one predetermined characteristic of the first, second or third object.

13. A transceiver demonstrating a radio interface and a computing unit as well as a storage unit and a communications interface configured to carry out the method according to claim 1.

14. A System demonstrating at least one transceiver or a plurality of transmitting and/or receiving devices to carry out the method according to claim 1.

15. A group of at least a total of three, transceivers configured according to claim 13 to carry out the method pairwise.

16. A group of at least a total of three systems configured according to claim 14 to carry out the method pairwise.

17. The method according to claim 5, further comprising:
using an intermittent radio signal of at least one of the two objects to another object via the same radio interference.

18. The method according to claim 6, wherein the radio signals are channel-sounding signals.

19. The method according to claim 6, wherein the radio signals demonstrate a corresponding or pairwise constant frequency.

20. The method according to claim 6, wherein the radio signal are not modulated radio signals.
